(19) United States
(12) Patent Application Publication
(10) Pub. No.: US 2023/0157229 A1
(43) Pub. Date: May 25, 2023

(54) PROCESSES AND SYSTEMS FOR INCREASING DRY MATTER IN HYDROPONICALLY GROWN CELLULOSIC MATERIALS

(71) Applicant: HydroGreen, Inc., Langley (CA)

(72) Inventor: Shawn Jenkins, Colton, SD (US)

(73) Assignee: HydroGreen, Inc., Langley (CA)

(21) Appl. No.: 17/534,027

(22) Filed: Nov. 23, 2021

(51) Int. Cl. A01G 31/06; A01G 24/22; A01G 24/30

(52) U.S. Cl. CPC A01G 31/06; A01G 24/22; A01G 24/30

(57) ABSTRACT

A system, method, and apparatus for increasing dry matter in plants is disclosed. A grower system for growing plants and crops provides an aerobic environment by controlling a plurality of environmental factors that decrease environmental stresses surrounding the plants or crops. The decrease in environmental stresses increases hydrolytic enzyme activity and releases additional hydrolytic enzymes. The hydrolytic enzymes breakdown a plurality of complex storage molecules of the plant or crop into simple storage molecules, increasing adenosine triphosphate production, given the plant more energy to increase dry matter.

### FIELD OF THE INVENTION

The present invention relates to plant dry matter more particularly, but not exclusively, the present invention relates to processes and compositions for increasing dry matter in hydroponically grown cellulosic materials.

### BACKGROUND

Livestock needs to consume a certain amount of dry matter per day to maintain their health. Fresh pastures and pan systems have a high-water content and a lower percentage of dry matter. Plant growth and the amount of dry matter are greatly affected by the environment. Most plant problems such as decreased dry matter are caused by environmental stress. Environmental factors such as water, humidity, nutrition, light, temperature, level of oxygen present can affect a plants growth and development. What is needed is a process, apparatus, and system for increasing dry matter in animal feed, forage crops, or food crops by controlling environmental factors and oxygen availability.

### SUMMARY

In one aspect of the present disclosure a grower system for increasing dry matter in plants is disclosed. The grower system may include a seed bed operably supported by a framework and disposed across a length and width of the framework. The seed bed has a first side opposing a second side and a first terminal end opposing a second terminal end. The seed bed is configured to house a plurality of seeds. The grower system may further include at least one seed egress disposed on the first side of the seed bed. The seed bed may receive or house some or all the plurality of seeds as the plurality of seeds expand. The grower system may further include a liquid source operably connected to the framework and configured to house a liquid and one or more liquid applicators operably secured to the framework adjacent the growing surface for discharging the liquid from the liquid source onto the plurality of seeds housed on the seed belt. The one or more liquid applicators is configured to discharge the liquid. The seed bed may drain excess liquid from the plurality of seeds providing an aerobic environment. The aerobic environment increases dry matter.

In another aspect of the present disclosure a method for increasing the dry matter in plants is disclosed. The method may include providing an aerobic environment utilizing a grower system configured to control a plurality of environmental factors. The method may also include increasing an oxygen supply to the plurality of seeds wherein the plurality of seeds expands on to a seed egress of the grower system. The method may also include irrigating the plurality of seeds with a liquid and breaking down a plurality of complex storage molecules into a plurality of simple molecules within the at least one seed by hydrolysis. The method may further include producing adenosine triphosphate utilizing the plurality of simple sugars and growing the at least one seed to maturity, wherein dry matter of the at least one seed is increased by the production of adenosine triphosphate.

In another aspect of the present invention, another method for increasing the dry matter in plants is disclosed. The method includes placing a plurality of seeds on a seed bed of a growing system and controlling a plurality of environmental factors of the seed bed by the grower system, wherein a plurality of environmental stresses are reduced. The method may further include supplying the seed bed with oxygen and light and irrigating the seed bed with a liquid, wherein the liquid comprises at least water. The method may also include releasing a plurality of enzymes within the plurality of seeds and hydrolyzing a plurality of complex storage molecules by the plurality of enzymes. The hydrolysis breaks down the plurality of storage molecules into simple storage molecules. The method may further include utilizing the simple storage molecules to produce adenosine triphosphate and utilizing the oxygen to increase the production of adenosine triphosphate. Lastly, the method may include increasing dry matter of the plurality of seeds, wherein the dry matter is increased by the increased production of adenosine triphosphate.

Therefore, it is a primary object, feature, or advantage of the present invention to improve over the state of the art.

It is a further object, feature, or advantage of the present invention to increase the activity of endogenous enzymes to break down complex storage molecules.

It is a still further object, feature, or advantage of the present invention to increase the production of adenosine triphosphate by controlling a plurality of environmental factors.

Another object, feature, or advantage is to provide a grower system for decreasing a plant's environmental stresses during growth.

Yet another object, feature, or advantage is to release a plurality of hydrolytic enzymes to hydrolyze complex storage molecules into simple storage molecules used in the product of adenosine triphosphate to increase dry matter of a plant by controlling the environment surrounding the plant.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is an illustration of the interaction between phytohormones and dry matter in accordance with an illustrative aspect of the disclosure.

FIG. 2A is a pictorial representation of animal feed grown under hypoxic conditions.

FIG. 2B is a pictorial representation of animal feed grown under aerobic conditions.

FIG. 3 is chart illustrating ATP production under different environmental conditions.

FIG. 4 is an illustration of the interaction between phytohormones in accordance with an illustrative aspect of the disclosure.

FIG. 5 is an illustration of the hydrolysis reaction of cellulose and xylan.

FIG. 6 is an illustration depicting the hydrolysis of maltose into two glucose molecules.

FIG. 7 is an illustration depicting Adenosine Triphosphate production.

FIG. 8 is a chart illustrating the germination percentage of barley over different hydrogen peroxide concentrations and salinity treatments in accordance with an illustrative aspect of the disclosure.

FIG. 9 is an illustration of the grower system in accordance with an illustrative aspect of the disclosure.

FIG. 10 is a side perspective view of a portion of the seed bed of the growing system in accordance with an illustrative aspect of the disclosure.

FIG. 11 is another side perspective view of a portion of the grower system illustrating a seed bed thereof.

FIG. 12 is a side perspective view of a portion of the grower system illustrating another seed bed thereof.

FIG. 13 is an end perspective view of a portion of the grower system further illustrating the seed bed shown in FIG. 12.

FIG. 14 is a side perspective view of a portion of the grower system illustrating another seed bed thereof.

FIG. 15 is a block diagram illustrating another perspective of the grower system.

FIG. 16 is a flowchart illustrating a method for increasing dry matter.

FIG. 17 is a flowchart illustrating a method for increasing dry matter.

### DETAILED DESCRIPTION

This disclosure relates to the use of an oxygen rich environment produced during controlled hydroponic germination of seeds for increasing dry matter in animal feedstuffs including feed concentrates, forages, and mineral supplements. Leveraging metabolic processes common to higher plants during germination and seedling development and plant's environment, the grower system enables the transformation of complex polysaccharides including starch and cellulose, complex proteins, and triglycerides into their reduced monosaccharide, amino acid, and fatty acid precursors, respectively. Thereby enabling the production of additional ATP and increasing the amount of dry matter.

The plant or seed may refer to any plant from the kingdom Plantae or angiosperms including flowering plants, cereal grains, grain legumes, grasses, roots and tuber crops, vegetable crops, fruit plants, pulses, medicinal crops, aromatic crops, beverage plants, sugars and starches, spices, oil plants, fiber crops, latex crops, food crops, feed crops, plantation crops or forage crops.

Cereal grains may include rice (Oryza sativa), wheat (Triticum), maize (Zea mays), rye (Secale cereale), oat (Avena sativa), barley, (Hordeum vulgare), sorghum (Sorghum bicolor), pearl millet (Pennisetum glacucum), finger millet (Eleusine coracana), barnyard millet (Echinochloa frumentacea), Italian millet (Setaria italica), kodo millet (Paspalum scrobiculatum), common millet (Panicum millaceum).

Pulses may include black gram, kalai, or urd (Vigna mungo var, radiatus), chickling vetch (Lathyrus sativus), chickpea (Cicer arietinum), cowpea (Vigna sinensis), green gram mung (Vigna radiatus), horse gram (Macrotyloma uniflorum), lentil (Lens esculenta), moth bean (Phaseolus aconitifolia), peas (Pisum sativum) pigeon pea (Cajanas cajan, Cajanus indicus), philipesara (Phaseolus trilobus), soybean (Glycine max).

Oilseeds may include black mustard (Brassica nigra), castor (Ricinus communis), coconut (Cocus nucifera), peanut (Arachis hypgaea), Indian mustard (Brassica juncea), toria (Napus), niger (Guizotia abyssinica), linseed (Linum usitatissumun), safflower (Carthamus tinctorious), sesame (Seasmum indicum), sunflower (Helianthus annus), white mustard (Brassica alba), oil palm (Elaeis guniensis). Fiber crops may include sun hemp (Crotalaria juncea), jute (Corchorus), cotton (Gossypium), mesta (Hibiscus), or tobacco (Nicotiana).

Sugar and starch crops may include potato (Solanum tberosum), sweet potato (Ipomea batatus), tapioca (Manihunt esculenta), sugarcane (Saccharum officinarum), sugar beet (Beta vulgaris). Spices may include black pepper (Piper nigrum) betel vine (Piper betle), cardamom (Elettaria cardamomum), garlic (Allium sativum), ginger (Zingiber officinale), onion (Allium cepa), red pepper or chillies (Capsicum annum), or turmeric (Curcuma longa). Forage grasses may include buffel grass or anjan (Cenchrus ciliaris), dallis grass (Paspalum dilatatum), dinanath grass (Pennisetum), guniea grass (Panicum maximum), marvel grass (Dicanthium annulatum), napier or elephant grass (Pennisetum purpureum), pangola grass (Digitaria decumbens), para grass (Brachiaria mutica), sudan grass (Sorghum sudanense), teosinte (Echlaena mexicana), or blue panicum (Panicum antidotale). Forage legume crops may include berseem or egyptian clover (Trifolium alexandrinum), centrosema (Centrosema pubescens), gaur or cluster bean (Cyamopsis tetragonoloba), Alfalfa or lucerne (Medicago sativa), sirato (Macroptlium atropurpureum), velvet bean (Mucuna cochinchinensis).

Plantation crops may include banana (Musa paradisiaca), areca palm (Areca catechu), arrowroot (Maranta arundinacea), cacao (Theobroma cacao), coconut (Cocos nucifera), Coffee (Coffea arabica), tea (Camellia theasinesis). Vegetable crops may include ash gourd (Beniacasa cerifera), bitter gourd (Momordica charantia), bottle gourd (Lagenaria leucantha), brinjal (Solanum melongena), broad bean (Vicia faba), cabbage (Brassica), carrot (Daucus carota), cauliflower (Brassica), colocasia (Colocasia esulenta), cucumber (Cucumis sativus), double bean (Phaseolus lunatus), elephant ear or edible arum (Colocasia antiquorum), elephant foot or yam (Amorphophallus campanulatus), french bean (Phaseolus vulgaris), knol khol (Brassica), yam (Dioscorea) lettuce (Lactuca sativa), must melon (Cucumis melo), pointed gourd or parwal (Trchosanthes diora), pumpkin (Cucrbita), radish (Raphanus sativus), bhendi (Abelmoschus esculentus), ridge gourd (Luffa acutangular), spinach (Spinacia oleracea), snake gourd (Trichosanthes anguina), tomato (Lycoperscium esculentus), turnip (Brassica), or watermelon (Citrullus vulgaris).

Medicinal crops may include aloe (Aloe vera), ashwagnatha (Withania somnifera), belladonna (Atropa belladonna), bishop's weed (Ammi visnaga), bringaraj (Eclipta alba), cinchona (Cinchona sp.) coleus (Coleus forskholli), dioscorea, (Dioscorea), glory lily (Gloriosa superba), ipecae (Cephaelis ipecauanha), long pepper (Poper longum), prim rose (Oenothera lamarekiana), roselle (Hibiscus sabdariffa), sarpagandha (Rauvalfia serpentine) senna (Cassia angustifolia), sweet flag (Acorus calamus), or valeriana (Valeriana wallaichii).

Aromatic crops may include ambrette (Abelmoschus moschatus), celery (Apium graveolens), citronella (Cymbopogon winterianus), geranium (Pelargonium graveolens), Jasmine (Jasminum grantiflorum), khus (Vetiveria zizanoids), lavender (Lavendula sp.) lemon grass (Cymbopogon flexuosus), mint, palmarosa (Cymbopogon martini), patchouli (Pogostemon cablin), sandal wood (Santalum album), sacred basil (Ocimum sanctum), or Tuberose (Polianthus tuberosa). Food crops are harvested for human consumption and feed crops are harvested for livestock consumption. Forage crops may include crops that animals feed on directly or that may be cut and fed to livestock.

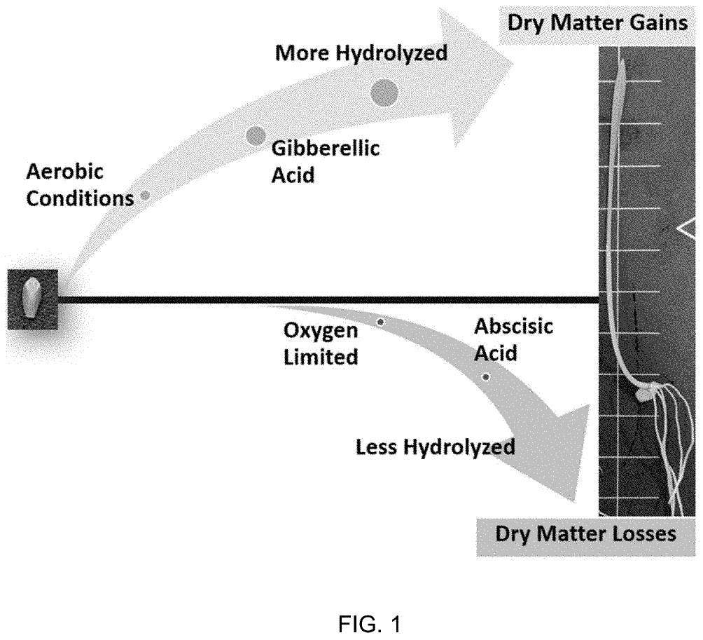

Dry matter is the part of animal feed or crop that remains after its water content is removed. Dry matter includes carbohydrates, fats, proteins, vitamins, minerals, nutrients or antioxidants. Livestock needs to consume a certain amount of dry matter per day to maintain their health. Fresh pastures have a high-water content and a lower percentage of dry matter. What is needed is a process, apparatus and system for increasing dry matter in animal feed, forage crops, or food crops. Plant growth and the amount of dry matter are greatly affected by the environment. Most plant problems such as decreased dry matter are caused by environmental stress. Environmental factors such as water, humidity, nutrition, light, temperature, level of oxygen present can affect a plants growth and development as shown in FIGS. 1-3.

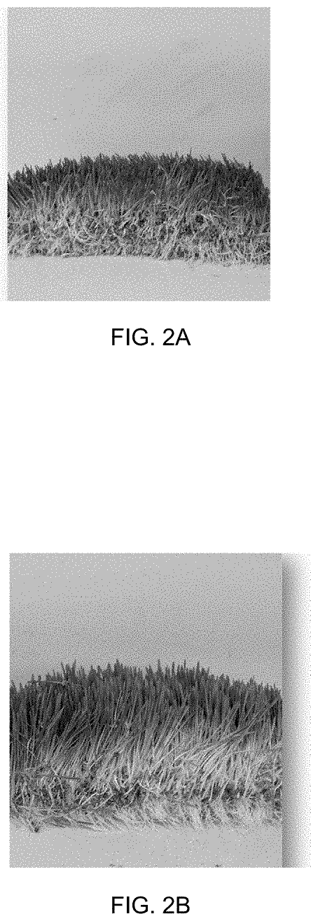

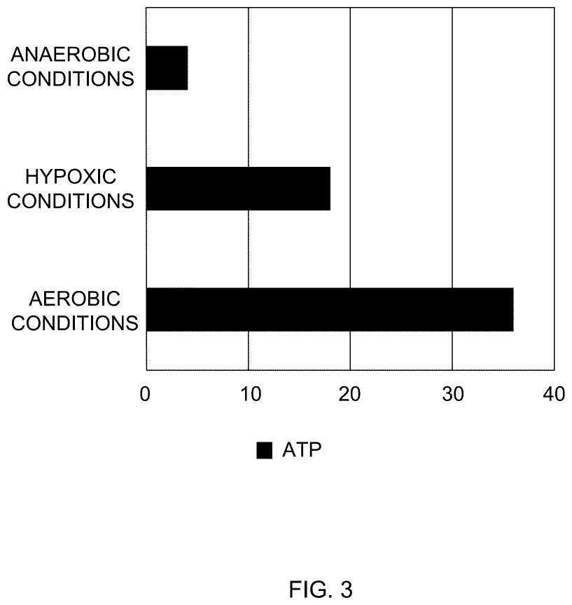

Oxygen is a necessary component in many plant processes included respiration and nutrient movement from the soil into the roots. The amount of oxygen can influence the efficiency of respiration. Oxygen moves passively into the plant through diffusion. Plants growing in anaerobic conditions, where the uptake or disappearance of oxygen is greater than its production by photosynthesis or diffusion by physical transport from the surrounding environment. Anaerobic conditions can cause nutrient deficiencies or toxicities within the plant, root or plant death, reduced growth of the plant, or reduced dry matter. Anaerobic conditions may be caused by a decrease in the amount of oxygen in the air, such as growing a plant or seed in a room without air or oxygen circulation. However, oxygen bound in compounds such as nitrate (NO₃), nitrite (NO₂), and sulfites (SO₃) may still be present in the environment. Waterlogging, where excess water in the root zone of the plant or in the soil which inhibits gaseous exchange with the air can also cause anaerobic conditions. Hypoxic conditions arise when there is insufficient oxygen in a plants environment and the plant must adapt its growth and metabolism accordingly. Excessive watering or waterlogged soil can cause hypoxic conditions. When anaerobic or hypoxic conditions persist, the microbial, fungal and plant activities quickly use up any remaining oxygen. The plant becomes stressed due to the lack of nutrient uptake by the roots, the plant stomata begin to close, photosynthesis is reduced and dry matter decreases. A prolonged period of oxygen deficiency can lead to reduced yields, root dieback, plant death, or greater susceptibility to disease and pests as shown in FIG. 2A. Under aerobic conditions plant growth can thrive, as shown in FIG. 2B. Aerobic conditions are when there is enough oxygen molecules or compounds and energy present to carry out oxidative reactions, increase the plant's metabolism and increase dry matter, as shown in FIG. 3.

Light is a necessary component for plant growth and the increase in the production of enzymes, sugars and starches that increase dry matter. The more light a plant receives, the greater its capacity for producing food and energy via photosynthesis. The energy can be used to produce or increase the expression of enzymes that increase dry matter. Temperature influences most plant processes, including photosynthesis, transpiration, respiration, germination, and flowering. As temperature increases up to a certain point, photosynthesis, transpiration, and respiration increase. When the temperature is too low or exceeds the maximum point photosynthesis, transpiration, and respiration decrease. When combined with day-length, temperature also affects the change from vegetative to reproductive growth. The temperature for germination may vary by plant species. Generally, cool-season crops (e.g., spinach, radish, and lettuce) germinate between 55° to 65° F., while warm-season crops (e.g., tomato, petunia, and lobelia) germinate between at 65° to 75° F. Low temperatures reduce energy use and increase simple sugar storage whereas adverse temperatures, however, cause stunted growth and poor-quality plants. The specific control of temperature encourages maximum enzyme hydrolysis throughout development while potentially discouraging the cellular division near the onset of photosynthesis thereby increasing dry matter. Temperatures near the cardinal range of seeds is believed to support maximum enzyme hydrolysis approximately through the first 120 hours. Reducing temperatures below the cardinal value at 120 hours is believed to reduce metabolic activity in tissue readily exposed to the environment while having reduced influence on the seed within the cellulosic material layer decreasing dry matter.

Water and humidity play an important role in increasing dry matter. Most growing plants contain ninety percent water, Water is the primary component of photosynthesis and respiration. Water is also responsible for the turgor pressure needed to maintain cell shape and ensure cell growth. Water acts as a solvent for minerals and carbohydrates moving through the plant, acts as a medium for some plant biochemical reactions, increases enzyme production and expression, and cools the plant as it evaporates during transpiration. Water can regulate stomatal opening and closing thereby controlling transpiration and photosynthesis and is a source of pressure for moving roots through a growing medium such as soil. Humidity is the ratio of water vapor in the air to the amount of water the air can hold at the current temperature and pressure. Warm air can hold more water vapor than cold air. Water vapor moves from an area of high humidity to an area of low humidity. Water vapor moves faster if there is a greater difference between the area of high humidity and the area of low humidity. When the plant's stoma open, a plant's water vapor rushes outside the plant into the surrounding air. An area of high humidity forms around the stoma and reduces the difference in humidity between the air spaces inside the plant and the air adjacent to the plant, slowing down transpiration. If air blows the area of high humidity around the plant away, transpiration increases.

Plant nutrition plays an important role in increasing dry matter. Plant nutrition is the plant's need for and use of basic chemical elements. Plants need at least 17 chemical elements for normal growth. Carbon, hydrogen, and oxygen can be found in the air or in water. The macronutrients, nitrogen, potassium, magnesium, calcium, phosphorus, and sulfur are used in relatively large amounts by plants. Nitrogen plays a fundamental role in energy metabolism, protein synthesis, and is directly related to plant growth. It is indispensable for photosynthesis activity and chlorophyll formation. It promotes cellular multiplication. A nitrogen deficiency results in a loss of vigor and color. Growth becomes slow and leaves fall off, starting at the bottom of the plant. Calcium attaches to the walls of plant tissues, stabilizing the cell wall and favoring cell wall formation. Calcium aids in cell growth, cell development and improves plant vigor by activating the formation of roots and their growth. Calcium stabilizes and regulates several different processes. Magnesium is essential for photosynthesis and promotes the absorption and transportation of phosphorus. It contributes to the storage of sugars within the plant. Magnesium performs the function of an enzyme activator. Sulfur is necessary for performing photosynthesis and intervenes in protein synthesis and tissue formation.

The plant micronutrients or trace elements, iron, zinc, molybdenum, manganese, boron, copper, cobalt, and chlorine, are used by the plant in smaller amounts. Macronutrients and micronutrients can be dissolved by water and then absorbed by a plant's roots. A shortage in any of them leads to deficiencies, with different adverse effects on the plant's general state, depending upon which nutrient is missing and to what degree. Fertilization may affect dry matter. Fertilization is when nutrients are added to the environment around a plant. Fertilizers can be added to the water or a plant's growing surface, such as soil. Additional micronutrients and macronutrients can be added to the plant by the grower system.

Plant growth can be split into four growing stages: imbibition, plateau, germination, and seedling. Imbibition is the uptake of water by a dry seed. As the seed intakes the water, the seed expands, enzymes are released, and food supplies become hydrated. The enzymes become active, and the seed increases its metabolic activity. During imbibition the relative humidity is high and may range from 90% to 98% relative humidity. The temperature may range from 76° F. to 82° F. or 22° C. to 28° C. Air movement is minimal. The imbibition may last 18 to 24 hours. The plateau stage is where water uptake increases very little. The plateau stage is associated with hormone metabolism such as abscisic acid and gibberellic acid (GA) synthesis or deactivation. During the plateau stage humidity and temperature may be lower than the imbibition stage. Relative humidity may range from 70% to 90% and the temperature may range from 72° F. to 77° F. or 22° C. to 26° C. Air movement may still be minimal. The plateau stage may last 18-24 hours. Germination is the sprouting of a seed, spore, or other reproductive body. The absorption of water, temperature, oxygen availability and light exposure may operate in initiating the process. During germination, the relative humidity may be lower than the imbibition and plateau stage. Relative humidity may range from 60% to 70%. The temperature may be the same as the plateau stage and range from 72° F. to 77° F. or 22° C. to 26° C. Air movement may be moderate. Germination may last 24 to 48 hours. The last phase is the seedling or plant development phase where the plant's roots develop and spread, nutrients are absorbed fueling the plants rapid growth. The seedling stage may last until the plant matures. The seedling stage may also be broken down into additional phases: seedling, budding, flowering and ripening. The relative humidity may be lowest at this stage and range from 40% to 60%. The temperature may also be the lowest at this stage and range from 68° F. to 72° F. or 20° C. to 22° C. Air movement is high. The seedling phase can range from 72 hours or until the plant reaches maturity.

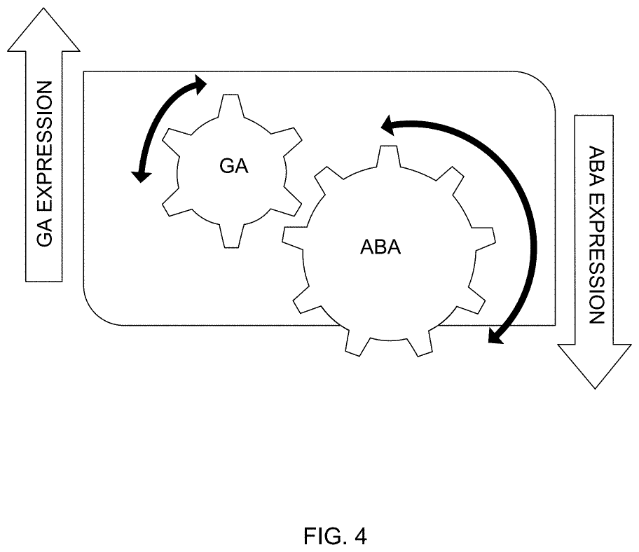

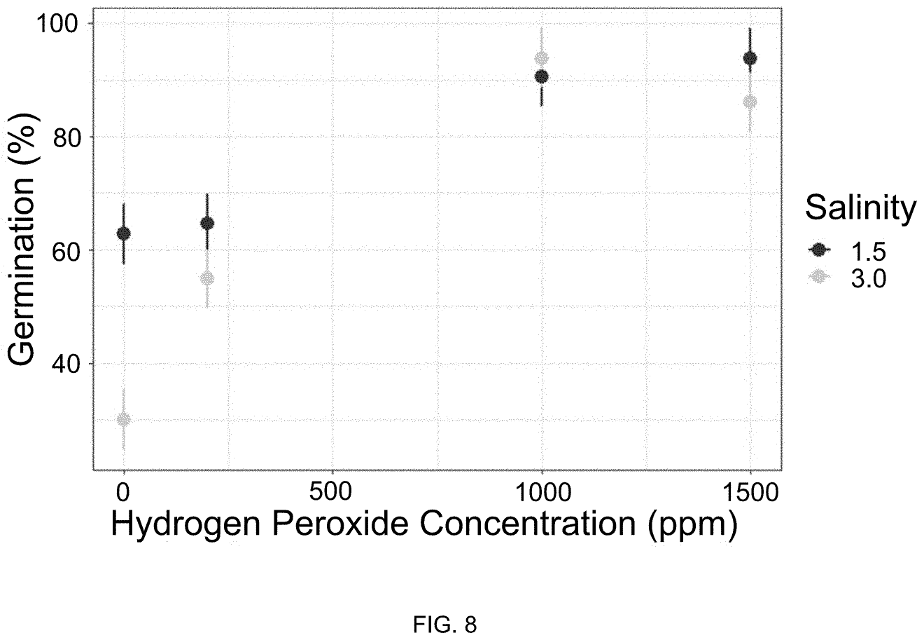

Phytohormones, such as abscisic acid (ABA), GA and ethylene (ET) regulate seed dormancy and seed germination as well as balance or dictate enzyme production. The ratio of ABA and GA regulates seed dormancy. When levels of ABA are high, stomatal closure, stress signaling and delay in cell division is triggered down regulating metabolic and decreasing dry matter. High ABA/GA ratios favor dormancy, whereas low ABA/GA ratios result in seed germination. The increase in GA is necessary for seed germination to occur, as GA expression increases, ABA expression decreases, as shown in FIG. 4. The external introduction of ROS can jumpstart a seed's germination and end dormancy. ROS action during seed germination, as shown in FIG. 2, is based on interactions between phytohormones that regulated seed dormancy or seed germination such as ABA, GA, and ethylene (ET). ABA inhibits ROS-mediated effects on seed germination by the promotion of ROS scavenging enzyme activity. The ratio of ABA and GA regulates seed dormancy, as shown in FIG. 3. High ABA/GA ratios favor dormancy, whereas low ABA/GA ratios result in seed germination. High ABA/GA ratios can be counteracted by the controlled introduction of reactive oxygen species (ROS) into the soil or growing surface or directly onto the seed or plant. The ROS are absorbed by the seed or plant. GA can also counteract the ROS-scavenging enzymes by downregulating the enzymes. The ROS can also oxidize ABA as well, decreasing the amount of ABA to GA. In some cases, ROS can release seed dormancy by activating GA signaling and synthesis rather than the repression of ABA signaling or ABA catabolism. ROS then subsequently acts as a signal molecule to antagonize ABA signaling. External ROS can increase internal ROS content of a seed synthesizing or activating additional GA or repression of more ABA signals. The external application of ROS decreases ABA levels and increases GA concentrations, which triggers seed germination. However, the amount or concentration of ROS may need to be monitored. Above certain limits, ROS are either too low to allow germination or too high and affect embryo viability and therefore prevent or delay germination. This creates an ‘oxidative window’ for germination that restricts proficient seedling development within certain borders of increased ROS levels. FIG. 8 illustrates the germination percentage of barley over differing H₂O₂ concentrations and salinity treatments. Salinity treatment expressed as salinity concentration in parts per thousand. The values shown in FIG. 8 are expressed in a fixed effect linear model estimation with 95 percent confidence interval illustrating the surrounding estimate. Through the application of ROS, the inhibitory influence of ABA included reduced stem elongation and germination is reduced.

GA triggers cell division, stem elongation and root development. Enzyme expression is closely linked to metabolic needs during germination. As the plant becomes metabolically active shortly after imbibition, GA is released from the seed embryo signaling the release of a wide profile of enzymes from within the seed including from the aleurone layer surrounding the polysaccharide and protein rich endosperm of the seed.

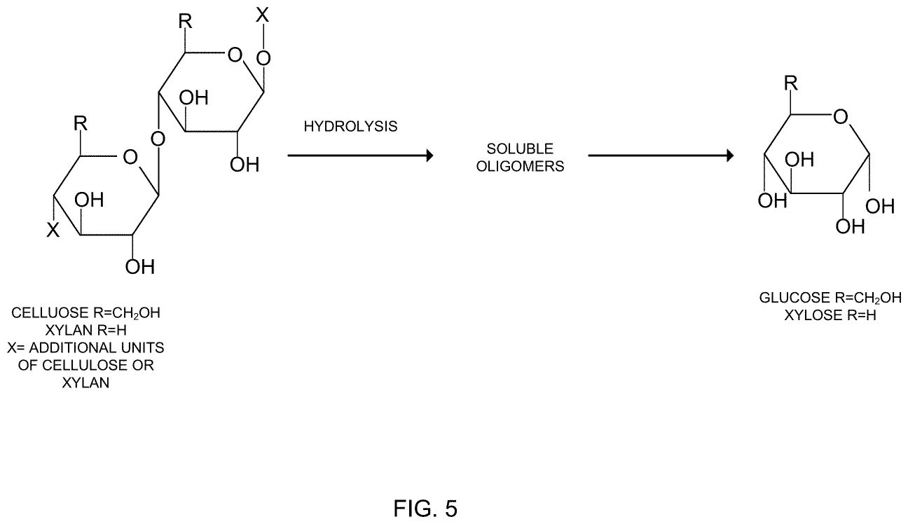

Hydrolytic enzymes are some of the most energy efficient enzymes. The hydrolytic enzymes, such as 1,3; 1,4-β-glucanase (β-glucanase), α-amylase and β-amylase, are released. The term “beta-glucosidase’ means a beta-D-glucoside glucohydrolase that catalyzes the hydrolysis of terminal non-reducing beta D-glucose residues with the release of beta-D-glucose. Once the hydrolytic enzymes are released, they facilitate the hydrolysis of complex storage molecules including cell wall polysaccharides, proteases, storage proteins, and starchy energy reserves that are essential for germination, providing sugars that drive the root growth, into their simpler monomer subunits. Hydrolysis of the storage molecules is one of the primary energy sources of plants. The hydrolytic enzymes break the polymers into dimers or soluble oligomers and then into monomers by water splitting the chemical bonds, as shown in FIG. 5.

β-glucanase may hydrolyze 1,3;1,4-β-glucan, a predominant cell wall polysaccharide. The α-amylase cleaves internal amylose and amylopectin residues. The β-amylase exo-hydrolase liberates maltose and glucose from the starch molecules. These reduced nutrient forms are commonly then transported back to the embryo where glycolysis and the cellular respiration pathway uses glucose to produce ATP needed for energy intensive cellular division and biosynthesis reactions. As the metabolic needs of the juvenile plant increases, the release of GA from the seed embryo and the release of enzymes from the aleurone layer likewise increases. Enzyme activity within the juvenile plant peaks at the onset of efficient photosynthesis. At this point, the total metabolic demands of the plant are not able to be met by photosynthesis and a large amount of storage molecules must be hydrolyzed to glucose for glycolysis and ATP generation.

Cellulose polysaccharides are the prominent biomass of the primary cell wall, followed by hemicellulose and pectin. Cellulosic material is any material containing cellulose. The secondary cell wall, produced after the cell has stopped growing, also contains polysaccharides and is strengthened by polymeric lignin covalently cross-linked to hemicellulose. Cellulose is a homopolymer of anhydrocellobiose and is a linear beta-(1-4)-D-glucan. Hemicellulose can include a variety of compounds, such as, Xylans, Xyloglucans, arabinoxylans, and mannans in complex branched structures with a spectrum of Substituents. Cellulose, although polymorphous, is primarily found as an insoluble crystalline matrix of parallel glucan chains. Hemicellulose usually hydrogen bonds to cellulose as well as other hemicelluloses, stabilizing the cell wall matrix. Cellulolytic enzymes or cellulase mean one or more enzymes that hydrolyze a cellulose material. The enzymes may include endoglucanase(s), cellobiohydrolase(s), beta-glucosidase(s), or combinations thereof. The enzymes break the cellulosic material down into cellodextrin or completely into glucose. Hemicellulolytic enzyme or hemicullase are one or more enzymes that hydrolyze a hemicellulosic material forming furfural or arabinose and xylose.

Beta-xylosidase, or beta-D-xyloside xylohydrolase, catalyzes the exo-hydrolysis of short beta (1->4)-xylooligosaccharides to remove successive d-xylose residues from non-reducing termini and may hydrolyze xylobiose. Beta-xylosidase engage in the final breakdown of hemicelluloses. The term “xylanase” means a 1,4-beta D-xylan-Xylohydrolase that catalyzes the endohydrolysis of 1,4-beta-D-Xylosidic linkages in Xylans. The term “endoglucanase” means an endo-1,4-(1,3:1,4)-beta-D-glucan 4-glucanohydrolase that catalyzes endohydrolysis of 1,4-beta-Dglycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans or Xyloglucans, and other plant material containing cellulosic components.

Lignin is another primary component of the cell wall. Lignin is a class of complex polymers that form key structural materials in support tissues, such as the primary cell wall, in most plants. The lignols that crosslink to form lignin are of three main types, all derived from phenylpropane: coniferyl alcohol (4-hydroxy-3-methoxyphenylpropane), sinapyl alcohol (3,5-dimethoxy-4-hydroxyphenylpropane), and paracoumaryl alcohol (4-hydroxyphenylpropane. Lignin fills the spaces in the cell wall between cellulose, hemicellulose, and pectin components. It can covalently crosslink to hemicellulose mechanically strengthening the cell wall. Ligninolytic enzymes are enzymes that hydrolyze lignin polymers. The ligninolytic enzymes include lignin peroxidases, manganese peroxidases, laccases and feruloyl esterase, and other enzymes described in the art known to depolymerize or otherwise break lignin polymers. Also included are enzymes capable of hydrolyzing bonds formed between hemicellulosic sugars (notably arabinose) and lignin.

Lipids are used as structural components to limit water loss and pathogen infection. These lipids include waxes derived from fatty acids, as well as cutin and Suberin. Lipase is an enzyme that hydrolyzes lipids, fatty acids, and acylglycerides, including phosphoglycerides, lipoproteins, diacylglycerols, and the like. Lipases include the following classes of enzymes: triacylglycerol lipase, phospholipase A2, lysophospholipase, acylglycerol lipase, galactolipase, phospholipase A1, dihydrocoumarin lipase, 2-acetyl-1-alkylglycerophosphocholine esterase, phosphatidylinositol deacylase, cutinase, phospholipase C, phospholipase D, 1-hosphatidylinositol phosphodiesterase, and alkylglycerophospho ethanolamine phosphdiesterase. Lipase increases the digestibility of lipids by breaking lipids down digestibly saccharides, disaccharides, and monomers.

Phytate is the main storage form of phosphorous in plants. However, many animals have trouble digesting or are unable to digest enzymes because they lack enzymes that break phytate down. Because phosphorus is an essential element, inorganic phosphorous is usually added to animal feed. Phytase is a hydrolytic enzyme that specifically acts on phytate, breaking it down and releasing organic phosphorous. The term “phytase” means an enzyme that hydrolyzes ester bonds within myo-inositol-hexakisphosphate or phytin. Including 4-phytase, 3-phytase, and 5-phyates. By increasing the activity of the hydrolytic enzymes, organic phosphorous is released and inorganic phosphorous does not have to be added to animal feed.

Protease breaks down proteins and other moieties, such as sugars, into smaller polypeptides and single amino acids by hydrolyzing the peptide bonds. Many of the proteins serve as storage proteins. Some specific types of proteases include cysteine proteases including pepsin, papain and serine proteases including chymotrypsins, carboxypeptidases and metalloen dopeptidases. Proteases play a key role in germinations through the hydrolysis and mobilization of proteins that have accumulated in the seed. Proteases also play a role in programmed cell death, senescence, abscission, fruit ripening, plant growth, and N homeostasis. In response to abiotic and biotic stresses, proteases are involved in nutrient remobilization of leaf and root protein degradation to improve yield.

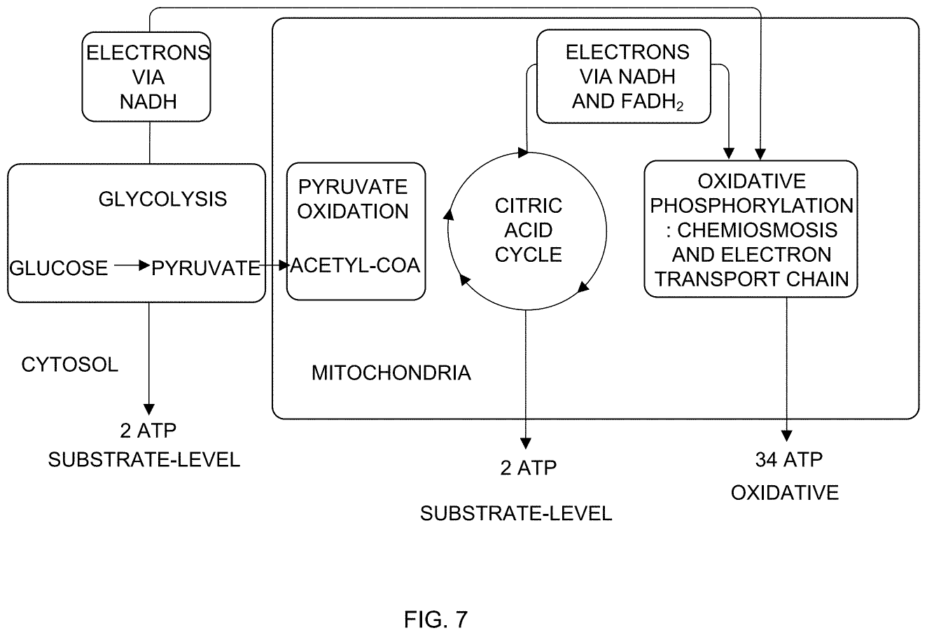

Cellular respiration is a set of metabolic reactions that take place in the cells of the seed to convert chemical energy from oxygen molecules or nutrients into adenosine triphosphate (ATP), as shown in FIG. 7. Nutrients, such as sugar, amino acids and fatty acids are used during cellular respiration. Oxygen is the most common oxidizing agent. Aerobic respiration requires oxygen to create ATP and is the preferred method of pyruvate in the breakdown into glycolysis. The energy transferred is used to break bonds in adenosine diphosphate (ADP) to add a third phosphate group to form ATP by phosphorylation, nicotinamide adenine dinucleotide (NADH) and flavin adenine dinucleotide (FADH₂). NADH and FADH₂ is converted to ATP using the electron transport chain with oxygen and hydrogen being the terminal electron acceptors. Most of the ATP produced during aerobic cellular respiration is made by oxidative phosphorylation. Oxygen releases chemical energy which pumps protons across a membrane creating a chemiosmotic potential to drive ATP synthase.

Aerobic metabolism is much more efficient than anaerobic metabolism which yields 2 molecules of ATP per 1 molecule of glucose instead of 34 molecules of ATP per 1 molecule of glucose. The double bond in oxygen has higher energy than other common biosphere molecule's double bonds or single bonds. Aerobic metabolism continues with the critic acid or Krebs cycle and oxidative phosphorylation.

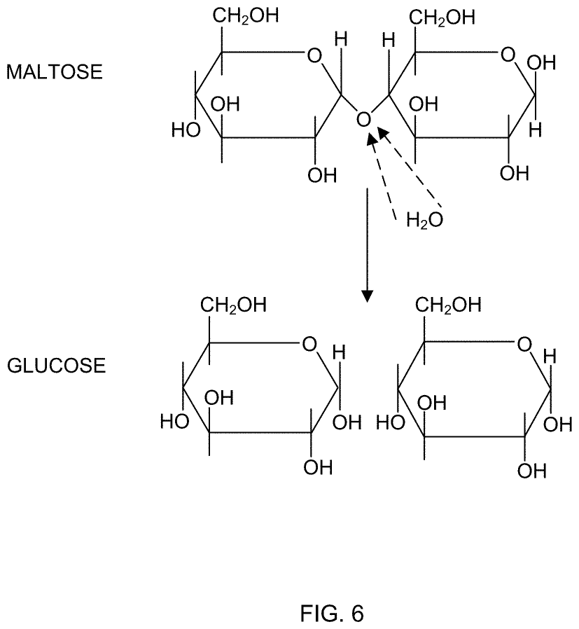

The efficiency of plant cellular respiration is influenced by the availability of oxygen. Specifically, the oxidative phosphorylation metabolic pathway or the electron transport-linked phosphorylation pathway requires the presence of oxygen for transfer of electrons from NADH or FADH₂. Hypoxic conditions expected while sprouting seedlings in a saturated environment or in a compressed environment, such as in a pan system with no room for expansion, thereby directly limit the maximum efficiency of oxidative phosphorylation. Processes allowing for the germination of grains with water drainage and space for seed expansion facilitate increased available oxygen concentrations throughout development. Encouraging the efficiency of oxidative phosphorylation enables dry matter increases through the buildup of monomers such as glucose. When complex molecules such as oligosaccharides are hydrolyzed into their simpler monomer units, chemical energy from the water molecule is converted into a dry matter form, as shown in FIG. 6. The cleavage of the water molecule and the disaccharide's oxygen bond enables the transformation of chemical energy within water to metabolically available forms. Utilizing the monomers in the most efficient manner enables increases enzyme release which increases in dry matter at the onset of efficient photosynthesis.

Glycolysis occurs with or without the presences of oxygen. Under aerobic conditions the process converts one molecule of glucose into two molecules of pyruvate (pyruvic acid) and 2 molecules of ATP. The initial phosphorylation of glucose is required to increase the reactivity in order for the molecule to be cleaved into two pyruvates by the enzyme aldolase. During the pay-off phase of glycolysis, four phosphate groups are transferred to ADP by substrate-level phosphorylation to make four ATP, and two NADH are produced when the pyruvate is oxidized. The citric acid cycle produces acetyl-CoA from the pyruvate molecules when oxygen is present. The acetyl-CoA is oxidized to CO₂ and NAD is reduced to NADH which can be used by the electron transport chain to create further ATP. If oxygen is not present, acetyl-CoA is fermented.

Oxidative phosphorylation comprises the electron transport chain and establish a chemiosmotic potential or proton gradient by oxidizing NADH produced during the citric acid cycle. ATP is synthesized using the ATP synthase enzyme where the chemiosmotic potential is used to drive the phosphorylation of ADP. The electron transfer is driven by the chemical energy provided from exogenous oxygen.

By decreasing environmental stresses and increasing metabolic activity, the plant can be harvested in an interval that closely aligns with the maximum point of enzyme activity within the plant's life cycle and increased development results. The nutrient or mineral content of animal feed or plant tissues may be expressed on a dry matter basis or the proportion of the total dry matter in the material. When enzyme activity is maximized the dry matter ratio can increase, such as by 118% in barley and 115% in wheat, instead of by 92% or 95%.

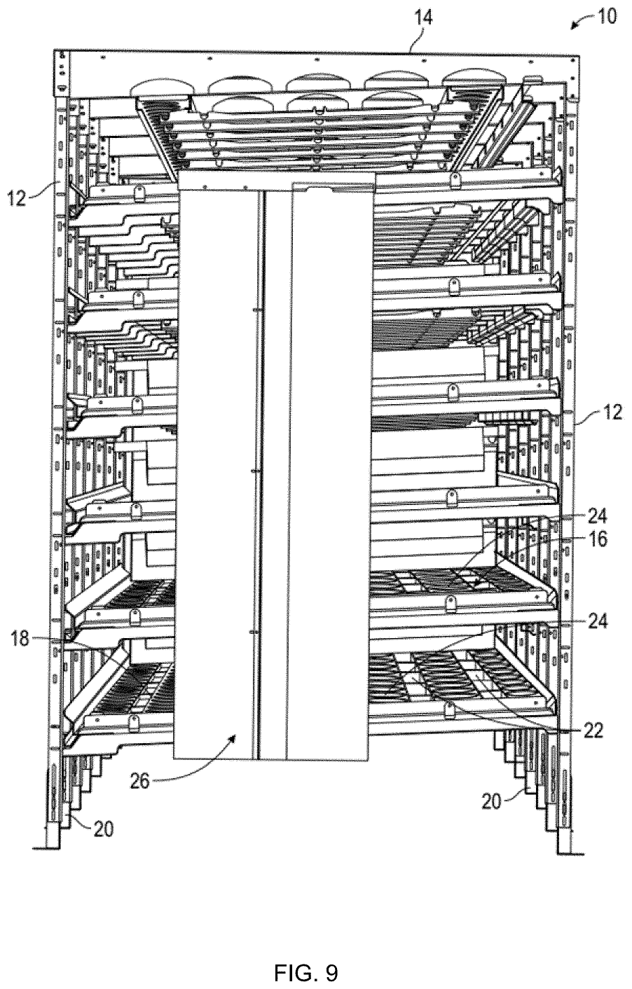

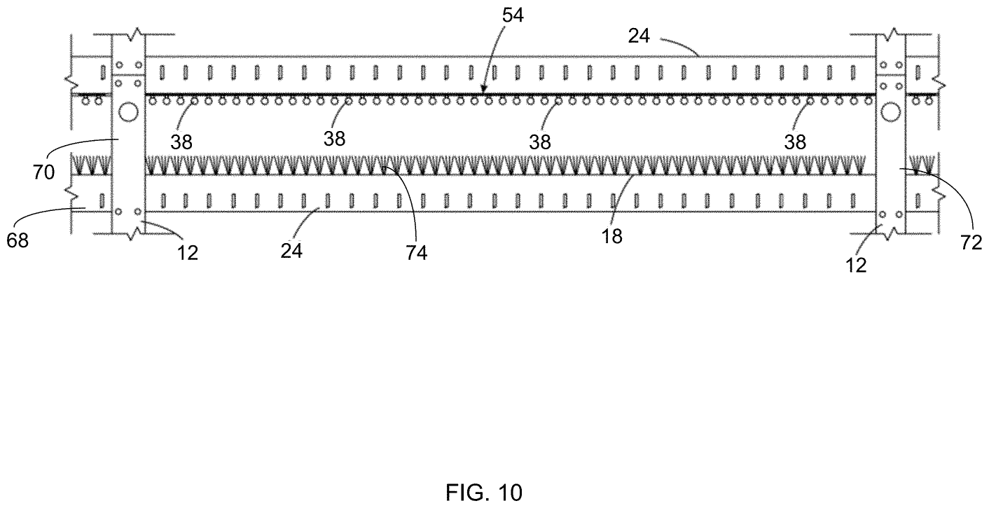

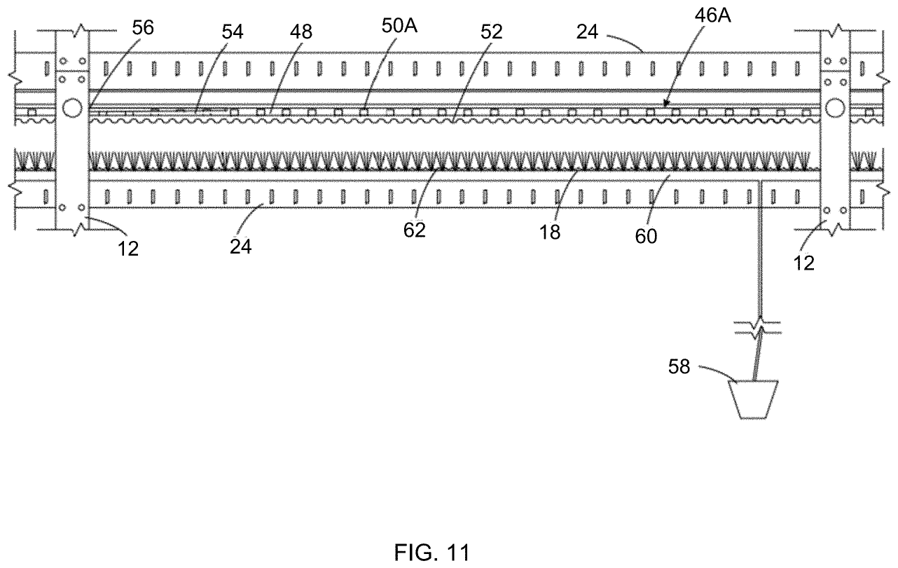

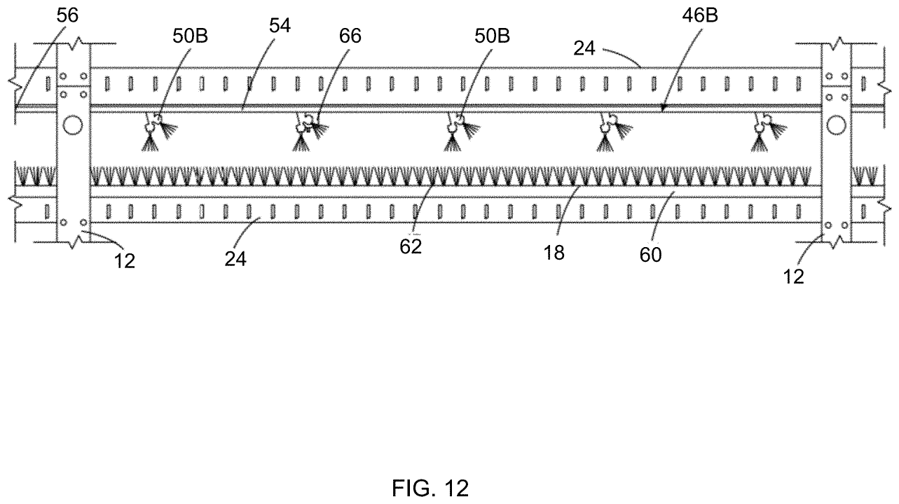

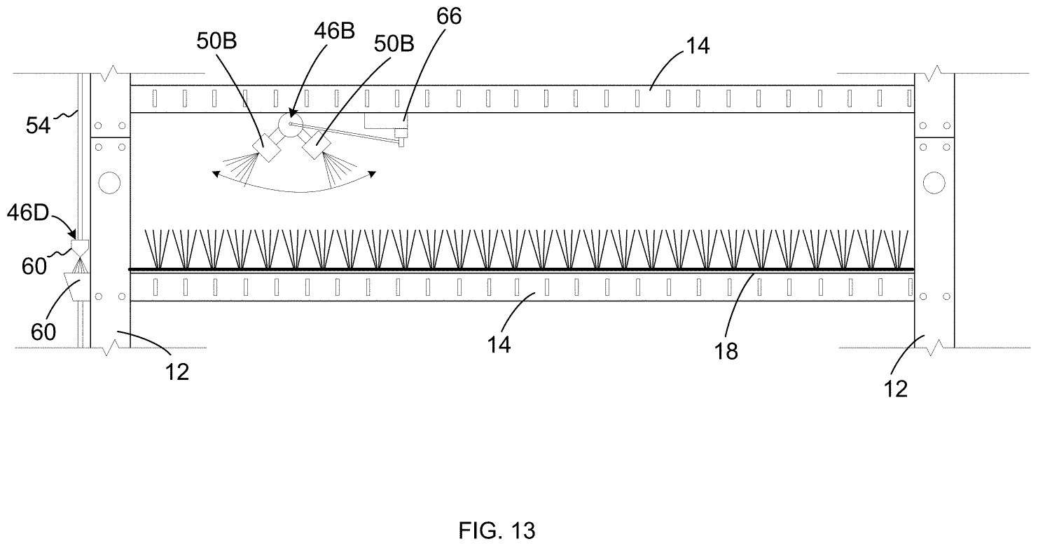

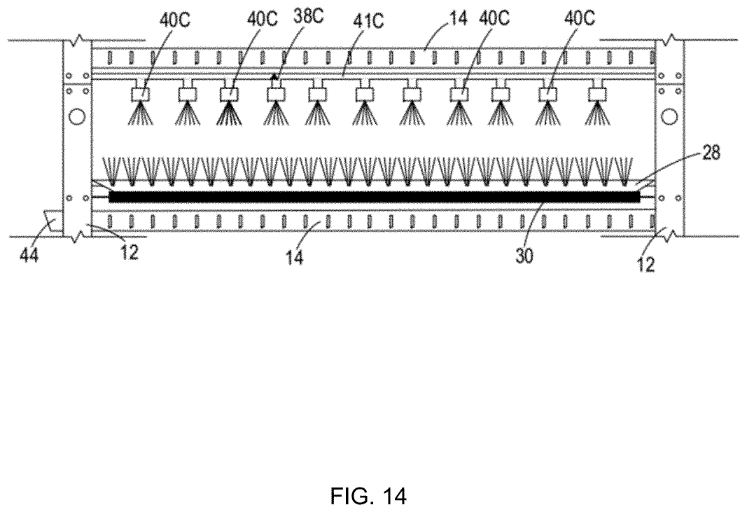

A grower system 10 can provide aerobic conditions allowing the plant to increase dry matter. The grower system 10, shown in FIGS. 9-16 comprises a plurality of vertical members 12 and a plurality of horizontal members 14 removably interconnected to form an upstanding seed growing table 16 with one or more seed beds 18. In some aspects of the present disclosure, the grower system 10 may have one or more seed beds 18. Each vertical member 12 can be configured to terminate at the bottom in an adjustable height foot 20. Each foot 20 can be adjusted to change the relative vertical position or height of one vertical member 12 relative to another vertical number 12 of the seed growing table 16. The horizontal member 14 can be configured to include one or more lateral members removably interconnected with one or more longitudinal members 24. A pair of vertical members 12 are separated laterally by a lateral member 22 thereby defining the width or depth of the seed growing table 16. Longitudinal members 24 are removably interconnected with lateral members 22 by one or more connectors 26.

Each seed bed 18 includes a seed belt 28, such as a seed film, operably supported by seed growing table 16. Seed belt 28 can be configured according to the width/depth of seed growing table 16. By way of example, the width/depth of seed belt 28 can be altered according to changes in the width/depth of seed growing table 16. The seed belt 28 material can be hydrophobic, semi-hydrophobic or permeable to liquid. In at least one aspect, a hydrophobic material they be employed to keep liquid atop the seed belt 28. In another aspect, a permeable or semi-permeable material can be employed to allow liquid to pass through the seed belt 28. Advantages and disadvantages of both are discussed herein. Traditional pans use hydrophobic material as part of the seed bed. This may increase water stress as water stays within the seed bed for prolonged periods, creating hypoxic conditions and increasing the concentration of ABA. The seeds use up the available oxygen. In one aspect, seed belt 28 is discontinuous and has separate or separated terminal ends. The seed belt 28 has a length of at least the length of the seed bed 18 and generally a width of the seed bed 18 and is configured to provide a seed bed for carrying seed. The seed belt 28 is configured to move across the seed bed 18. Seed belt 28 rests upon and slides on top of horizontal members 14. One or more skids or skid plates (not shown) may be disposed between seed belt 28 and horizontal members 14 to allow seed belt 28 to slide atop horizontal members 14 without binding up or getting stuck. The seed bed 18 or seed belt 28 may be positioned at a slope to encourage the drainage of water facilitating an increased oxygenated environment when compared to a pan type fodder set up.

To provide room for expansion the seed belt 28 or seed bed 18 may have a seed egress 68 on one or more sides of the seed bed 18, such as a first side 70 and an opposing second side 72. The seed egress 68 allows room for expansion as the seeds 74 grow, lessening the growth compression of the seeds 74. If the seed bed 18 has walls on the first side 70 or the second side 72. The walls may prevent the seeds 74 from expanding thereby compressing some or all of the seeds. The compressed seeds may receive little to no oxygen resulting in hypoxic or anaerobic conditions. The seed egress 68 is not covered with seeds during seed out. The empty space allows for expansion as the seed doubles in volume in the first few growth stages, such as in the first 24 hours. If the seeds do not have room to expand the seed may be subjected to a dense environment with reduced heat, water and oxygen exchange capabilities.

Each seed bed 18 may include a liquid applicator 46A, 46B, and/or 46C operably configured atop each seed bed 18 for irrigating seed disposed atop each seed bed 18. The seed may be irrigated with water. The dimensions of the seed bed 18 may be configured to accommodate need, desired plant output, or maximization of enzyme activity. Liquid applicator 46A may be configured adjacent at least one longitudinal edge of seed bed 18. Liquid applicator 46A may also be operably configured adjacent at least one lateral edge of seed bed 18. Preferably, liquid applicator 46A may be configured adjacent a longitudinal edge of seed bed 18 to thereby provide drip-flood irrigation to seed bed 18 and seed 74 disposed atop seed bed 18. Liquid applicator 46A may include a liquid guide 48 and liquid distributor 50A, 50B, 50C with a liquid egress 52 having a generally undulated profile, such as a sawtooth or wavy profile generally providing peak (higher elevated) and valley (lower elevated) portions. Liquid applicator 46A can include a liquid line 54 configured to carry liquid 62 from a liquid source 56, such as a liquid collector 58 or plumbed liquid source 56. Liquid 62 may exit liquid line 54 through one or more openings and may be captured upon exiting liquid line 54 by liquid guide 48 and liquid distributor 50A. The one or more openings in liquid line 54 can be configured as liquid drippers, intermittently dripping a known or quantifiable amount of liquid 62 over a set timeframe into liquid guide 48. The one or more openings may be configured intermittently along a length of liquid line 54 or dispersed in groupings along a length of liquid line 54. The one or more openings in liquid line 54 can be operably configured to equally distribute the liquid 62 down the seed bed 18 and slowly drip liquid into the seed bed 18. Drip or flood irrigating the growing surface provides a layer of liquid 62 for soaking the seed and can provide liquid 62 to seed 74 on seed bed 18 in a controlled, even distributive flow. Liquid distributor 50A can be configured with a liquid guide 48 adapted to collect liquid 62 as it exits liquid line 54. Collected liquid may be evenly distributed by liquid distributor 50A and exit the liquid distributor 50A onto the seed bed 18 via the liquid egress 52.

According to at least one aspect, liquid 62 egressing from liquid distributor 50A may travel atop seed belt 28 beneath and/or between a seed mass 74 atop seed belt 28. Other configurations of liquid applicator 46 are also contemplated herein. For example, in one aspect, liquid 62 may enter liquid applicator 46 through a liquid line 54 and exit liquid line 54 through a plurality of openings. Liquid 62 from liquid line 54 may coalesce into a small reservoir creating a balanced distribution of liquid 62 across a length of liquid distributor 50A. When this small reservoir becomes full, the liquid 62 may run over and out of liquid egress 52, such as between the teeth of liquid egress 52. In this manner, liquid 62 may be equally distributed down an entire length and across an entire width of the seed bed 18. From liquid egress 52, liquid 62 may drip onto a seed belt 28 where it may run under a bulk of seed on the seed belt 28 to soak or make contact with the seed 74. The root system of seed 74 on the seed belt 28, along with a wicking effect, may move the liquid 62 up through the seed to water all the seeds and/or plants.

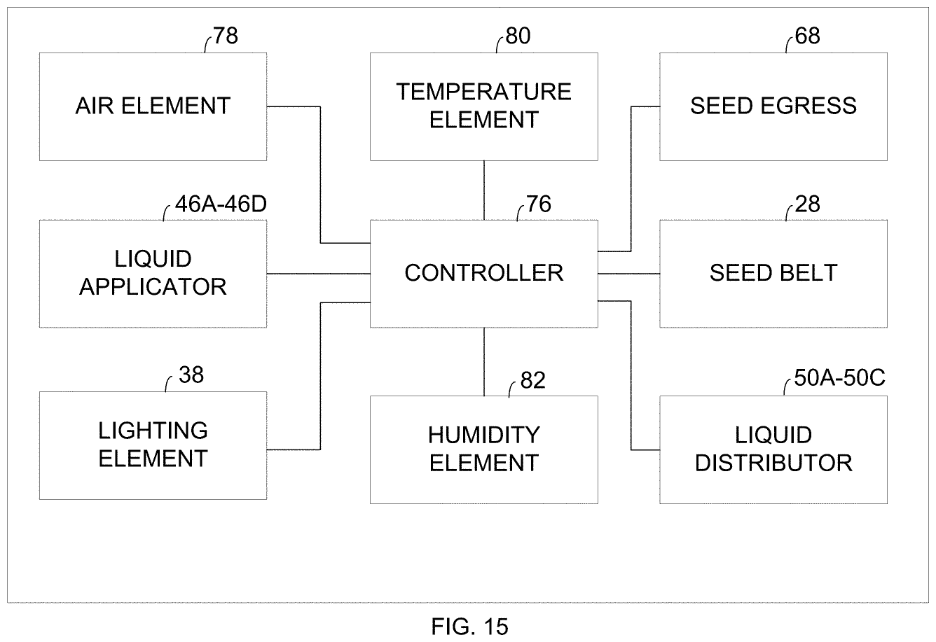

Liquid applicator 46B may be disposed atop each seed bed 18. Liquid applicator 46B may include a plurality of liquid distributors 50B operably configured in a liquid line 54 operably plumbed to a liquid source 56. Liquid distributor 50B can include spray heads, such as single or dual-band spray heads/tips, for spray irrigating seed disposed atop each seed bed 18. In one aspect, a plurality of liquid lines 54 may be disposed in a spaced arrangement atop each seed bed 18. Each liquid line 54 may traverse the length of the holding container and may be plumbed into connection with liquid source 56. Other liquid lines 54 can be configured to traverse the width of seed bed 18. Liquid 62 may be discharged from each liquid distributor 50B for spray irrigating seed atop each seed bed 18. In another aspect, each liquid line 54 may be oscillated back and forth over a 10°, 15°, 20°, 25°, 30°, 35°, 40°, 45°, or greater radius of travel for covering the entire surface area of the seed atop each seed bed 18. In the case where dual angle spray heads are used for liquid distributor 50B, the oscillation travel of each liquid line 54 can be reduced thereby reducing friction and wear and tear on liquid applicator 46B. The process of applying liquid to the seed or plant can be automated by a controller 76 (FIG. 15), graphical user interface, and/or remote control. A drive mechanism 66 can be operably connected to each liquid line 54 for oscillating or rotating each line through a radius of travel. Liquid applicator 46 can be operated manually or automatically using one or more controllers 76 operated by a control system.

Liquid applicator 46 may be configured to clean seed bed 18 of debris, contaminants, mold, fungi, bacteria, and other foreign/unwanted materials. Liquid applicator 46 can also be used to irrigate seed 74 with a disinfectant, nutrients, or reactive oxygen species as seed is released onto seed bed 18 from a seed dispenser. A time delay can be used to allow the reactive oxygen species or nutrients to remain on seed for a desired time before applying or irrigating with fresh water. The process of cleaning, descaling, and disinfecting seed bed 18 using liquid applicator 46D can be automated by a controller 76, graphical user interface, and/or remote control.

Liquid applicator 46 can be operated immediately after seeding of the seed bed 18 to saturate seed with liquid. Seed 74 in early, mid, and late stages of growth can be irrigated with liquid 62 using liquid applicator 46. Liquid applicators 46A-D can be operated simultaneously, intermittently, alternately, and independent of each other. During early stages of seed growth, both liquid applicators 46A-B are operated to best saturate seed to promote sprouting and germination. During later stages of growth, liquid applicator 46A can be used to irrigate more than liquid applicator 46B. Alternatively, liquid applicator 46B can be used to irrigate more than liquid applicator 46A, depending upon saturation level of seed growth. Liquid applicator 46C can be operated during seeding of seed bed 18 and movement of seed bed 18 in the second direction to spray seed dispensed atop seed bed 18 to saturate seed with liquid. The liquid provided to liquid applicators 46A-D could include additives, such as disinfectants, reactive oxygen species, fertilizer and/or nutrients. Nutrients, such as commonly known plant nutrients such as calcium and magnesium, can be added to liquid dispensed from liquid applicators 46A-D to promote growth of healthy plants and/or increase the presence of desired nutrients in harvested seed. Liquid applicators 46C-D can be used also to sanitize seed bed 18 before and/or after winding on or unwinding of the seed belt, the seed bed 18, or seed egress 68 of the seed belt.

Liquid distributors 46A-D and their various components, along with other components of the grower system 10, can be sanitized by including one or more disinfectants, such as reactive oxygen species used by each liquid distributor 50A-D. For example, liquid guide 48, liquid lines 54, liquid egress 52, drain trough 60, liquid collector 58, seed bed 18, liquid distributors 50A-C, and other components of the growing system. In another aspect, liquid applicators 46A-D can be used to clean and sanitize seed bed 18 before, between, or after seeding and harvesting. A separate liquid distributor or manifold can be configured to disinfect or sanitize any components of the growing system that carry liquid for irrigation and cutting or receive irrigation or cutting runoff from the one or more holding containers.

The liquid 62 may be constantly applied, or the applicator may apply the liquid 62 at a set time frame or at a quantifiable amount. For example, the liquid applicator 46A-D may apply the liquid 62 for a first time period such as 1 minute and then the liquid applicator may stop applying the liquid 62 for a second time period, such as 4 minutes, or 1 min of liquid application for every 5 minutes. The cycle may continue until the developmental phase or seed out phase terminates. In another example, the liquid 62 may be applied for 10 min every 2 hours. The liquid applicator 46 may provide a controlled, evenly distributed flow allowing the liquid 62 to reach a maximum number of seeds. Excess liquid 62 may be captured, recycled, and reused by the grower system 10. If the seed bed 18 has an egress or a slant, the slant may aid in the even distribution of the liquid as it egresses through the seed bed 18. In some aspects, the liquid applicator 46 may guide the distribution of the liquid to areas within the seed bed 18, a portion of the seeds 74, or a portion of the plants 74 that need more application. The liquid applicators 46 may also oscillate to cover the larger areas of the seed bed 18 or the entire length and width of the seed bed 18 or seed belt 28.

Each seed bed 18 includes one or more lighting elements 38 housing lights for illuminating seed atop seed belt 28 to facilitate hydroponic growth of seed or a seed mass atop seed belt 28. Lighting elements 38 are operably positioned directly/indirectly above each seed bed 18. Lighting elements 38 can be turned off and on for each level using a controller 76. Lighting elements 38 can be powered by an electrochemical source or power storage device, electrical outlet, and/or solar power. In one aspect, lighting elements 38 are powered with direct current power. Contemplated lighting elements 38 include, for example, halide, sodium, fluorescent, and LED strips/panels/ropes, but are not limited to those expressly provided herein. One or more reflectors (not shown) can be employed to redirect light from a remote source not disposed above each seed bed 18. Lighting elements 38 can be operably controlled by a controller 76, a timer, user interface or remotely. Operation of lighting elements 38 can be triggered by one or more operations of grower 10. For example, operation of a seed belt 28 can trigger operation of lighting elements 38. The process of lighting a seed bed 18 can be automated by controller 76, graphical user interface, and/or remote control. In one aspect, lighting elements 38 are low heat emission, full ultraviolet (UV) spectrum, light emitting diodes that are cycled off and on with a controller 76, preferably on 18 hours and off 6 hours in a 24-hour period.

The grower system 10 or each seed bed 18 at least one air element 78 such as a fan or HVAC system to control air movement around the seed bed. The air element 78 is operable connected to the controller 76. A room or environment where the grower system 10 is stored may also have one or more fans used to control air movement. The air movement or flow may be changed depending on the developmental phase of the seeds on the seed bed. A temperature element 80, such as an HVAC unit, is operably connected to the grower system 10, controller 76, or the seed bed 18 to control the temperature of the environment of the seed bed 18. The temperature element 80 may maintain temperatures ranging of 65 to 85 degrees F. or 18 to 30 degrees C. A humidity element 82 may be operably connected to the controller 76, growing system 10, or seed bed 18 for controlling the humidity of the environment of the seed bed 18. The humidity unit 82 may maintain a relative humidity level between 50% and 90%. The temperature element 80, air element 78, and humidity element 82 may all include the same HVAC unit. The temperature and air humidity may be changed depending on the developmental phase of the seeds on the seed bed. The process of controlling the air movement, temperature, and humidity of a seed bed 18 can be automated by controller 76, graphical user interface, and/or remote control. The lighting, temperature, air flow, and liquid application may all affect the humidity of the seed bed 18.

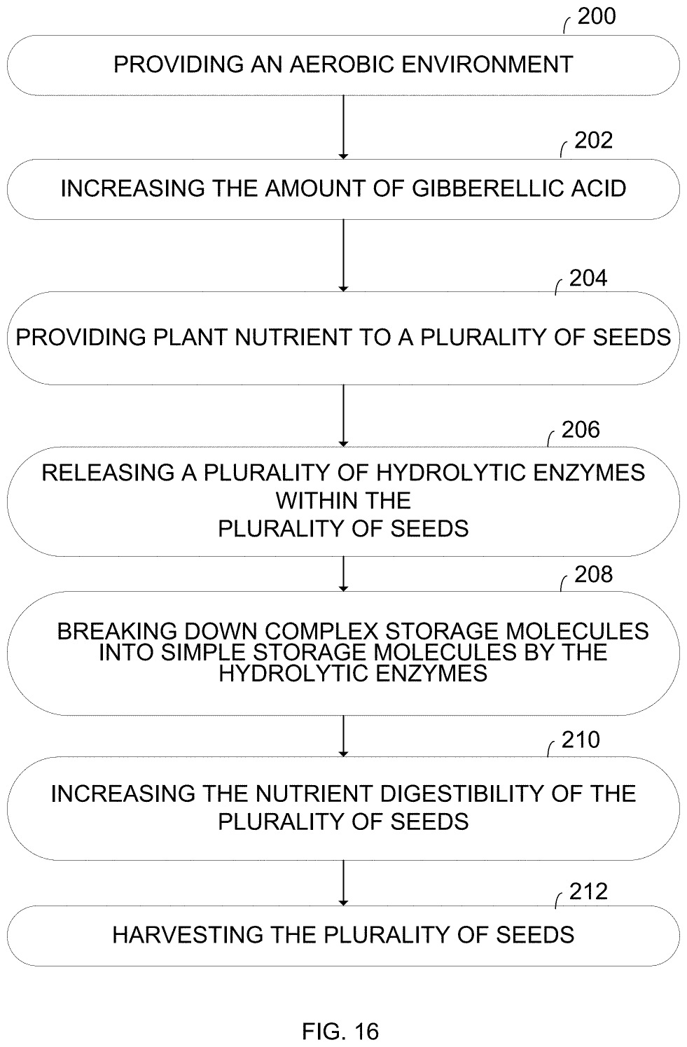

A method for increasing the dry matter in plants utilizing a controlled environment is disclosed and shown in FIG. 16. First, an aerobic environment utilizing the grower system is provided (Step 200). The grower system may be configured to control a plurality of environmental factors including temperature, air movement, humidity, lighting, irrigation, and oxygen availability. Next the oxygen supply to the plurality of seeds is increased (Step 202). The seeds may be housed on a seed bed of the grower system, utilizing the aerobic environment to germinate and reach maturity. A seed egress on the grower system allows for the seeds to expand as they grow, uncompressing the seeds and providing the seeds with an increased supply of oxygen. Next, the plurality of seeds are irrigated with a liquid (Step 204). ATP is produced utilizing the chemical energy produced from the breakdown of the complex storage molecules (Step 206). Next, a plurality of complex storage molecules are broken down into a plurality of simple sugar molecules by hydrolysis (Step 208). Next, the seeds grow to maturity where the dry matter of the seed or plant is increased, increasing the nutrient digestibility of the seed, by the breakdown of the plurality of complex storage molecules and the increase in production of ATP (Step 210). Lastly, the seeds are harvested when the hydrolytic enzyme activity is maximized thereby increasing dry matter (Step 212).

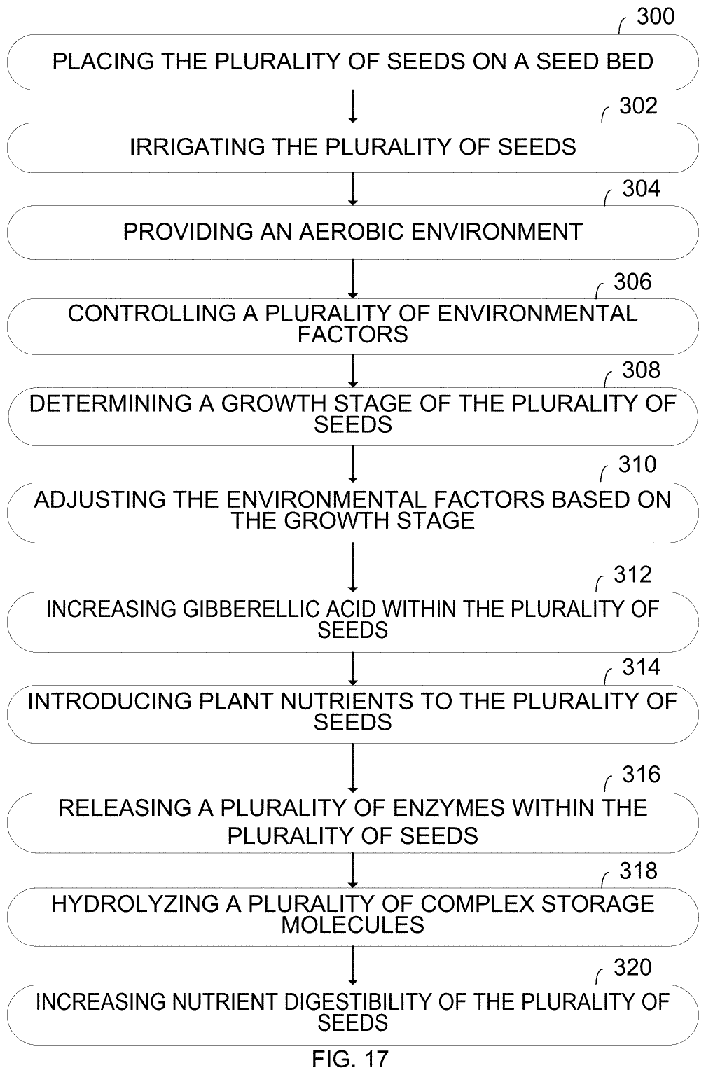

Another method for increasing dry matter in plants by increasing the production of ATP is disclosed and shown in FIG. 17. First, a plurality of seeds are placed on a seed bed of a growing system (Step 300). Next, a plurality of environmental factors of the seed bed are controlled (Step 306). Controlling a plurality of environmental factors may reduce environmental stresses. Next, the seed bed is supplied with oxygen and light (Step 304). Next, the seed bed is irrigated with a liquid (Step 302). The liquid may comprise at least water or one reactive oxygen species. Drainage of the liquid helps prevent the seed bed from being waterlogged. Next, a growth stage of the seeds is determined (Step 308). Next, the plurality of environmental factors are adjusted based on the growth stage of the seeds (Step 310). Next, a plurality of enzymes are released by an increase in gibberellic acid due to the environmental factors promoting the increase in gibberellic acid (Step 312). Next, a plurality of complex storage molecules are hydrolyzed into simple storage molecules by the plurality of enzymes, thereby releasing chemical energy (Step 314). Next, the simple storage molecules are used to produce ATP (Step 316). Next, the oxygen is utilized to increase the production of adenosine triphosphate (Step 318). Lastly, the increase in production of adenosine triphosphate increases the dry matter in and digestibility of plants (Step 320).

The disclosure is not to be limited to the particular aspects described herein. In particular, the disclosure contemplates numerous variations in increasing dry matter by affecting a plant's environment using a growing system. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes or methods of the disclosure. It is understood that any other modifications, substitutions, and/or additions can be made, which are within the intended spirit and scope of the disclosure.

What is claimed is:

1. A grower system for increasing dry matter in plants, the grower system comprising:
a seed bed operably supported by a framework and disposed across a length and width of the framework having a first side opposing a second side and a first terminal end opposing a second terminal end, wherein the seed bed is configured to house a plurality of seeds;
at least one seed egress disposed on the first side of the seed bed configured to receive the plurality of seeds as the plurality of seeds expand;
a liquid source operably connected to the framework and configured to house a liquid; and
one or more liquid applicators operably secured to the framework adjacent the growing surface for discharging the liquid from the liquid source onto the plurality of seeds housed on the seed belt, wherein the one or more liquid applicators is configured to discharge the liquid;
wherein the seed bed is configured to drain excess liquid from the plurality of seeds providing an aerobic environment;
wherein the aerobic environment increases dry matter.

2. The grower system of claim 1, wherein the seed egress is configured to provide the aerobic environment.

3. The grower system of claim 1, wherein the aerobic environment increases the production of adenine triphosphate.

4. The grower system of claim 1, wherein the grower system is configured to decrease environmental stresses of the plurality of seeds, wherein the decrease in the environmental stresses decreases the activity of abscisic acid.

5. The grower system of claim 1, wherein the liquid breaks down complex molecules into simple molecules increasing dry matter.

6. The grower system of claim 1, wherein the liquid comprises water and at least one reactive oxygen species.

7. The grower system of claim 1, wherein the grower system is configured to control a plurality of environmental factors surrounding the seed bed and where at least one of the environmental factors one of temperature or humidity.

8. A method for increasing dry matter in plants, the method comprising:
providing an aerobic environment utilizing a grower system configured to control a plurality of environmental factors;
increasing oxygen supply to the plurality of seeds wherein the plurality of seeds expand on to a seed egress of the grower system;
irrigating the plurality of seeds with a liquid;
breaking down a plurality of complex storage molecules into a plurality of simple molecules within the at least one seed by hydrolysis;
producing adenosine triphosphate utilizing the plurality of simple sugars; and
growing the at least one seed to maturity, wherein dry matter of the at least one seed is increased by the production of adenosine triphosphate.

9. The method of claim 8, wherein the at least some of the adenosine triphosphate is produced using oxidative phosphorylation and wherein the oxidative phosphorylation is driven at least in part by chemical energy provided from the aerobic environment.

10. The method of claim 8, wherein the environmental factors comprise water availability, oxygen availability, temperature, and humidity.

11. The method of claim 8, wherein the liquid comprises water and at least one reactive oxygen species.

12. The method of claim 8, further comprising:
providing plant nutrients to the plurality of seeds, wherein the plant nutrients comprise at least one of magnesium or calcium.

13. The method of claim 8 further comprising:
determining a growth stage of the plurality of seeds; and
adjusting the plurality of environmental factors based on the growth stage of the plurality of seeds.

14. The method of claim 8, wherein the liquid breaks down complex molecules into simple molecules increasing dry matter.

15. A method for increasing dry matter in plants, the method comprising:
placing a plurality of seeds on a seed bed of a growing system;
controlling a plurality of environmental factors of the seed bed by the grower system, wherein a plurality of environmental stresses are reduced;
supplying the seed bed with oxygen and light;
irrigating the seed bed with a liquid, wherein the liquid comprises at least water releasing a plurality of enzymes within the plurality of seeds;
hydrolyzing a plurality of complex storage molecules by the plurality of enzymes, wherein the hydrolysis breaks down the plurality of storage molecules into simple storage molecules;
utilizing the simple storage molecules to produce adenosine triphosphate;
utilizing the oxygen to increase the production of adenosine triphosphate;
increasing dry matter of the plurality of seeds, wherein the dry matter is increased by the increased production of adenosine triphosphate.

16. The method of claim 15, wherein the simple storage molecules comprise at least glucose.

17. The method of claim 15, further comprising:
determining a growth stage of the at least one seed;
adjusting the plurality of environmental factors based on the growth stage of the at least one seed, wherein the environmental factors include temperature and humidity.

18. The method of claim 15, further comprising:
providing an aerobic environment surrounding the seed bed, wherein water drains from the seed bed;
providing a seed egress configured to receive the plurality of seeds as the plurality of seeds expand.

19. The method of claim 15, further comprising:
introducing at least one plant nutrient to the plurality of seeds.

20. The method of claim 15, wherein the decrease in environmental stresses increases the activity of gibberellic acid.
